(19) United States
(12) Patent Application Publication
(10) Pub. No.: US 2023/0236091 A1
(43) Pub. Date: Jul. 27, 2023

(54) BLADE CLAMPING DEVICE FOR MICROTOME

(71) Applicant: Leica Biosystems Nussloch GmbH, Nussloch (DE)

(72) Inventors: Zheguang FAN, Pudong, Shanghai (CN); Song JIN, Pudong, Shanghai (CN)

(21) Appl. No.: 17/773,286

(22) PCT Filed: Oct. 31, 2019
(86) PCT No.: PCT/CN2019/114572

§ 371 Date: Apr. 29, 2022

(51) Int. Cl. G01N 1/06

(52) U.S. Cl. CPC G01N 1/06; G01N 2001/061

(57) ABSTRACT

A blade clamping device for a microtome is provided. The blade clamping device includes: a base part; a pressure plate rotatably connected to the base part via a rotation shaft; a clamping pin received in the base part, and configured to extend out of the base part and push the pressure plate to rotate, so as to clamp a blade between the base part and the pressure plate; and a drive unit received in the base part, connected to the clamping pin and configured to drive the clamping pin to extend out of the base part.

### FIELD

Embodiments of the present disclosure generally relate to a microtechnic filed, more particularly, to a blade clamping device for a microtome.

### BACKGROUND ART

In a present microtome, a blade is clamped by a blade clamping device. The blade clamping device includes two pressure plates, and the blade is adapted to be clamped between the two pressure plates. Further, the blade clamping also includes an eccentric bold for driving the two pressure plates to rotate towards each other, so as to clamp the blade. When a user needs to clamp the blade, he/she rotates the eccentric bolt in a direction. When the user needs release the blade, he/she rotates the eccentric bolt in a reverse direction.

Thus, in order to get a good clamping effect, the user has to provide a very big force to clamp the blade, and the user needs to clamp many times every day, which is very hard for the user. Further, the eccentric bolt and a part in contact with the eccentric bolt for clamping will be worn. After a certain time, when the wear reaches a certain level, the microtome will loss the clamping function. Moreover, it is difficult to get a uniform clamping force each time for the user.

### SUMMARY

Embodiments of the present disclosure seek to solve at least one of the problems existing in the prior art to at least some extent, and thus provide a blade clamping device for a microtome.

According to embodiments of a first broad aspect of the present disclosure, there is provided a blade clamping device. The blade clamping device includes: a base part; a rotation shaft connected to the base part; a pressure plate rotatably connected to the base part via the rotation shaft; a clamping pin received in the base part, and configured to extend out of the base part and push the pressure plate to rotate, so as to clamp a blade between the base part and the pressure plate; and a drive unit received in the base part, connected to the clamping pin and configured to drive the clamping pin to extend out of the base part.

In some embodiments of the present disclosure, the base part includes: a bottom wall; a side wall connected to the bottom wall and perpendicular thereto; and a top wall inclined and connected between the bottom wall and the side wall. The pressure plate is covered on the top wall of the base part.

In some embodiments of the present disclosure, the top wall includes a first oblique segment and a second oblique segment inclined at different angles with respect to the bottom wall.

In some embodiments of the present disclosure, the first oblique segment is inclined at a larger angle than the second oblique segment with respect to the bottom wall.

In some embodiments of the present disclosure, the pressure plate has an end connected to the base part via the rotation shaft, the end of the pressure plate has an inclined surface matched with the first oblique segment of the top wall of the base part, so as to define a gap therebetween when the end of the pressure plate is rotated around the rotation shaft towards the first oblique segment, and the gap is configured to receive the blade therein.

In some embodiments of the present disclosure, the base part further includes a receiving chamber, and the clamping pin and the drive unit are received in the receiving chamber of the base part. The clamping pin is configured to extend out of the top wall of the base part and configured to move in a direction substantially perpendicular to the top wall of the base part under an action of the drive unit.

In some embodiments of the present disclosure, the blade clamping device further includes an accommodating box arranged in the receiving chamber and configured to accommodate the clamping pin therein. The accommodating box includes a body and a cover connected to the body, and the clamping pin is received in the body and extends out of the cover.

In some embodiments of the present disclosure, the drive unit includes: a motor arranged parallel with the accommodating box; a first gear connected to an output shaft of the motor; and a second gear connected the accommodating box and meshed with the second gear.

In some embodiments of the present disclosure, the drive unit further includes a spindle connected to the second gear and passing through side walls of the accommodating box and supported thereby. The spindle is configured to rotate along with the second gear and abut against the clamping pin, so as to drive the clamping pin to move in the direction substantially perpendicular to the top wall of the base part under an action of the drive unit.

In some embodiments of the present disclosure, the drive unit further includes a nut fitted over the spindle and configured to move along the spindle when the spindle is rotated. The nut is further configured to abut against the clamping pin when moved along the spindle.

In some embodiments of the present disclosure, the nut is configured as a sleeve having internal threads, and the spindle is provided with external threads fitted with the internal threads of the nut, such that the nut is configured to move front and back through a thread fit between the nut and the spindle when the spindle is rotated under the drive of the second gear.

In some embodiments of the present disclosure, the nut includes an inclined side wall configured to be in contact with a bottom of the clamping pin, and the bottom of the clamping pin also includes an inclined surface fitted with the side wall of the nut. Both the side wall of the nut and the surface of the bottom of the clamping pin are inclined downwards in an extending direction of the spindle from the second gear.

In some embodiments of the present disclosure, the drive unit further includes a controller coupled to the motor and configured to turn on or off the motor. The controller is further configured to control the motor to rotate in a first direction to drive the pressure plate to clamp the blade, and also to control the motor to rotate in a second direction to drive the pressure plate to loosen the blade, in which the second direction is opposite to the first direction.

In some embodiments of the present disclosure, the drive unit further includes a motor drive integrated circuit connected between the motor and the controller, and configured to receive a signal from the controller to control the motor to operate.

In some embodiments of the present disclosure, the drive unit further includes a resistor connected in series with the motor, and the controller is configured to monitor a current from the motor through the resistor. The controller is further configured to turn off the motor when the current from the motor exceeds a preset current.

In some embodiments of the present disclosure, the drive unit further includes a position sensor arranged at an initial position of the nut, and configured to be triggered when the nut returns to is initial position and to send a signal to the controller. The controller is further configured to turn off the motor in response to the signal from the position sensor.

In the blade clamping device according to embodiments of the present disclosure, the blade can be clamped or released automatically, when the user presses a corresponding key. Thus, the user does not need to operate the blade clamping device manually, such that it is convenient for the user to use the microtome, and hence the user experience is enhanced. Further, the blade can be clamped with a uniform force each time, compared with manual clamping operations, and hence the clamping effect is also improved.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings.

FIG. 1 is a perspective view of a blade clamping device according to an embodiment of the present disclosure.

FIG. 2 is a sectional view of the blade clamping device illustrated in FIG. 1.

FIG. 3 is another sectional view of the blade clamping device illustrated in FIG. 1, in which a pressure plate is removed.

FIG. 4 is a partially enlarged view of portion A in FIG. 3.

FIG. 5 is another sectional view of the blade clamping device illustrated in FIG. 1.

FIG. 6 is a sectional view of the blade clamping device taken along a direction A-A in FIG. 2.

FIG. 7 is a block diagram of a drive unit of a blade clamping device according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, Unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, it is to be understood that phraseology and terminology used herein with reference to device or element orientation (such as, for example, terms like “central,” “upper,” “lower,” “front,” “rear,” and the like) are only used to simplify description of the present disclosure, and do not alone indicate or imply that the device or element referred to must have a particular orientation.

In addition, terms such as “first” and “second” are used herein for purposes of description and are not intended to indicate or imply relative importance or significance.

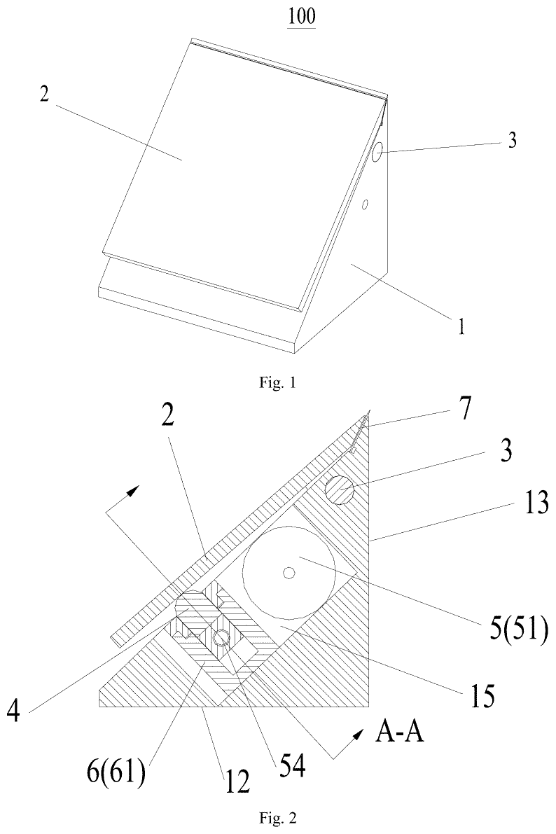

Embodiments of the present disclosure provide a blade clamping device 100. As illustrated in FIGS. 1-6, the blade clamping device 100 includes a base part 1, a pressure plate 2, a rotation shaft 3, a clamping pin 4 and a drive unit 5. The rotation shaft 3 is connected to the base part 1. The pressure plate 2 is rotatably connected to the base part 1 via the rotation shaft 3. The clamping pin 4 and the drive unit 5 are received in the base part 1. The clamping pin 4 is configured to extend out of the base part 1 and push the pressure plate 2 to rotate when moving, so as to clamp a blade between the pressure plate 2 and the base 1. The drive unit 5 is connected to the clamping pin 4 and configured to drive the clamping pin 4 to extend out of the base part.

As shown in FIGS. 2, 3 and 5, the base part 1 has a top wall 11, a bottom wall 12 and a side wall 13, the side wall 13 is connected to the bottom wall 12 and perpendicular thereto, and the top wall 11 is inclined and connected between the bottom wall 12 and the side wall 13. The top wall 11 includes a first oblique segment 111 and a second oblique segment 112 inclined at different angles with respect to the bottom wall 12. For example, the first oblique segment 111 is inclined at a larger angle than the second oblique segment with respect to the bottom wall 12.

The pressure plate 2 is covered on the top wall 11 of the base part 1, and rotatably connected to the base part 1 via the rotation shaft 3. That is, the pressure plate 2 is connected to the base part 1 and can be rotated with respect to the base part 1 via the rotation shaft 3.

Specifically, one end of the pressure plate 2 is connected to the base part 1 via the rotation shaft 3. The one end of the pressure plate 2 also has an inclined surface matched with the first oblique segment 111 of the top wall 11 of the base part 1, so as to define a gap therebetween, and thus a blade 7 may be clamped in the gap.

Further, as shown in FIG. 4, the first oblique segment 111 is configured as a blade rest, and a step portion 113 is provided at a connection of the first oblique segment 111 and the second oblique segment 112. A rear surface of the blade 7 is supported on the blade rest 111, and an end surface of the blade 7 is supported on the step portion 113. The end surface of the blade faces away from a cutting edge of the blade 7.

In some embodiments of the present disclosure, the first oblique segment 111 further includes a groove 114 adjacent to the step portion 113, such that it is convenient to remove the blade 7 from the blade rest 111 after the blade 7 has been tightly clamped between the pressure plate 2 and the base part 1 for a certain time. Thus, the blade 7 will not be stuck to the blade rest 111 after being tightly clamped between the pressure plate 2 and the base part 1 for a certain time.

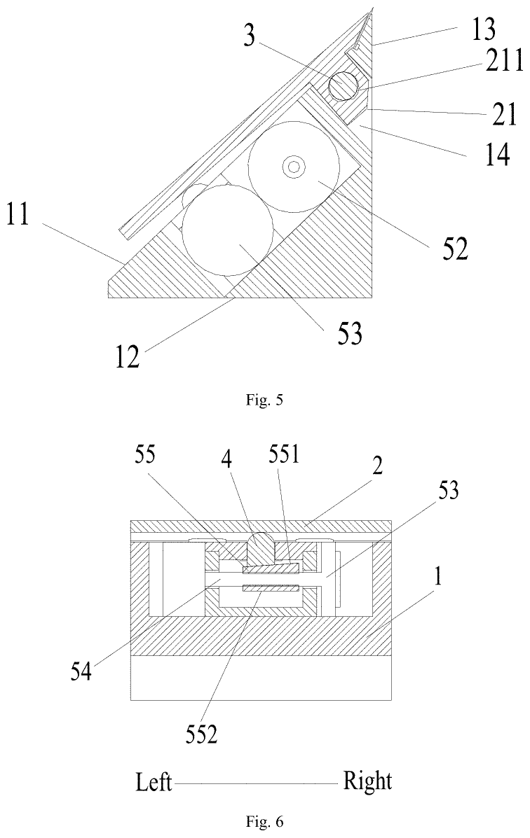

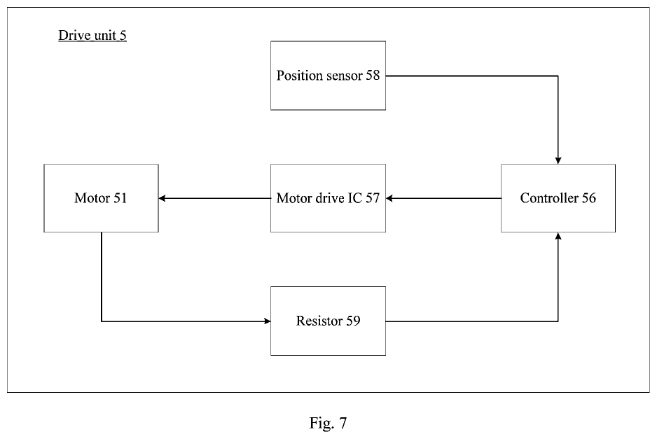

As shown in FIG. 5, the base part 1 includes a recess 14 in the second oblique segment 112 adjacent to the first oblique segment 111, and the pressure plate 2 includes a protrusion 21 extending into the recess 14. The protrusion 21 has a hole 211 therein, and the rotation shaft 3 passes through the hole 211 and connects the protrusion 21 to the base part 1. Further, a size of the recess 14 is larger than a size of the protrusion 21, such that the protrusion 21 can be rotated in the recess 14 by a certain degree which allows the pressure plate 1 to clamp the blade 7 with the base part 1 or to release the blade 7 from base part 1.

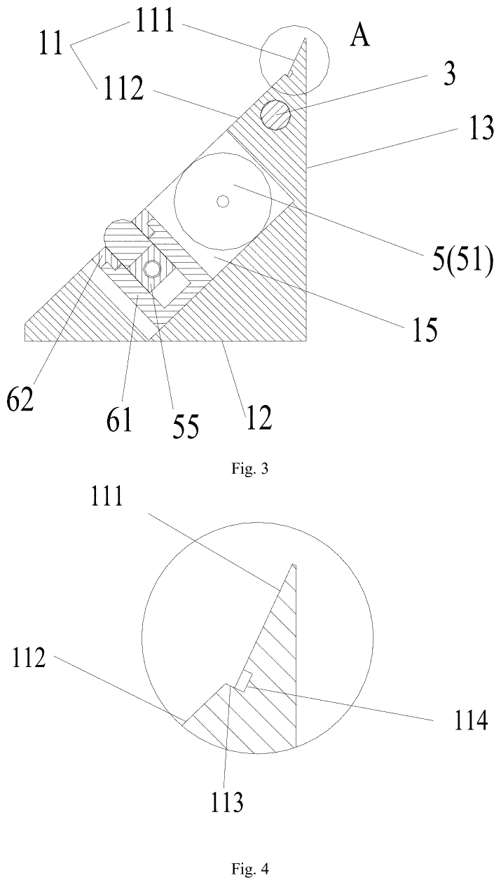

Further, as shown in FIGS. 2 and 3, the base part 1 also includes a receiving chamber 15, and the clamping pin 4 and the drive unit 5 are received in the receiving chamber 15 of the base part 1. The drive unit 5 is connected to the clamping pin 4 and configured to drive the clamping pin 4 to move up and down. The clamping pin 4 extends out of the top wall 11 of the base part 1 and configured to move in a direction substantially perpendicular to the top wall 11 of the base part 1 under an action of the drive unit 5.

Also as shown in FIGS. 2 and 3, the blade clamping device 100 further includes an accommodating box 6 arranged in the receiving chamber 15 and configured to accommodate the clamping pin 4 therein. The accommodating box 6 includes a body 61 and a cover 62 connected to the body 61. The clamping pin 4 is received in the body 61 and extends out of the cover 62. Further, the clamping pin 4 is configured to slide up and down in the direction substantially perpendicular to the top wall 11, while extending through the cover 62.

In some embodiments of the present disclosure, the accommodating box 6 is fixed in the receiving chamber 15, such that the clamping pin 4 can slide up and down stably, and thus the stability of operations of the blade clamping device 100 is improved.

In some embodiments of the present disclosure, as shown in FIGS. 2, 3, 5 and 6, the drive unit 5 includes a motor 51, a first gear 52 and a second gear 53. The motor 51 is arranged parallel with the accommodating box 6, the first gear 52 is connected to a output shaft of the motor 51, and the second gear 53 is connected the accommodating box 6. Further, the first gear 52 is meshed with the second gear 53, and thus the motor 51 can drive the second gear 53 to rotate via the first gear 52.

Moreover, the drive unit 5 further includes a spindle 54 configured to abut against the clamping pin 4, and the spindle 54 passes through side walls of the accommodating box 6 and supported thereby, such that the spindle 54 can drive the clamping pin 4 to move stably via abutting against the clamping pin 4. Further, the spindle 54 is connected to the second gear 53, and configured to rotate along with the second gear 53. In some embodiments of the present disclosure, the spindle 54 may be integral with the second gear 53.

Further, as shown in FIGS. 2, 3 and 5, the drive unit 5 also includes a nut 55, and the nut 55 is fitted over the spindle 54 and configured to move along the spindle 54 when the spindle 54 is rotated. In embodiments of the present disclosure, the nut 55 is configured to abut against the clamping pin 4 when moved along the spindle 54. Specifically, the nut 55 is configured as a sleeve having internal threads, and the spindle 54 is provided with external threads fitted with the internal threads of the nut 55, such that when the spindle 54 is rotated under the drive of the second gear 53, the nut 55 moves front and back through a thread fit between the nut 55 and the spindle 54.

Moreover, the nut 55 has a first side wall 551 configured to be in contact with a bottom of the clamping pin 4, and the first side wall 551 is inclined. Accordingly, the bottom of the clamping pin 4 also has an inclined surface fitted with the first side wall 551 of the nut 55. Further, the nut 55 also includes a second side wall 552 facing away from the first side wall 551, and the second side wall 552 may be inclined or not, which is not limited herein.

Further, both the first side wall 551 of the nut 55 and the surface of the bottom of the clamping pin 4 are inclined downwards in an extending direction of the spindle 54 from the second gear 53, e.g. in a direction from right to left, as shown in FIG. 6.

In this case, when the motor 51 operates to drive the first gear 52 and hence the second gear 53 to rotate, the spindle 54 is also driven to rotate, and thus the nut 55 also moves from right to left under the drive of the spindle 54, such that the nut 55 abuts against the bottom of the clamping pin 4 through its first side surface 551, and hence drives the clamping pin 4 to move upwards to a clamping position in the direction perpendicular to the top wall 11 of the base part 1. During the upward movement of the clamping pin 4, the clamping pin 4 drives the pressure plate 2 to rotate clockwise around the rotation shaft 3. When the clamping pin 4 reaches the clamping position, the blade 7 is clamped on the blade rest 111 between the pressure clamp 2 and the base part 1.

When the motor 51 operates to drive the first gear 52 and the second gear 53 to rotate in a reverse direction, the spindle 54 is also driven to rotate reversely, and thus the nut 55 moves from left to right under the drive of the spindle 54, such that the clamping pin 4 moves downwards to an initial position in the direction perpendicular to the top wall 11 of the base part 1, under the action of its own gravity. During the downward movement of the clamping pin 4, the pressure plate 2 rotates anticlockwise around the rotation shaft 3. When the clamping pin 4 reaches the initial position, the blade 7 is completely released for subsequent operations. For example, the blade 7 is ready to be replaced with another one.

In some embodiments of the present disclosure, as shown in FIG. 6, the drive unit 5 further includes a controller 56 coupled to the motor 51 and configured to turn on or off the motor 51. Specifically, the controller 56 is further configured to control the motor 51 to rotate clockwise to drive the pressure plate 2 to rotate clockwise, so as to clamp the blade 7, and also to control the motor 51 to rotate anti-clockwise to drive the pressure plate 2 to rotate anti-clockwise, so as to loosen the blade 7.

Further, the controller 56 may control the motor 51 to operate through a motor drive integrated circuit (IC) 57. For example, the motor drive IC 57 is connected between the motor 51 and the controller 56 and configured to receive a corresponding signal from the controller 56 to control the motor 51 to operate.

In some embodiments of the present disclosure, when the controller 56 gets an order to clamp the blade 7 from a user, e.g. the user presses a key of the microtome, the controller 56 sends a signal to the motor 51 to drive the motor 51 to rotate clockwise, so as to clamp the blade 7. Meanwhile, the controller 56 also monitors a current from the motor 51 through a resistor 59 connected in series with the motor 51. If the current exceeds a preset current, it indicates that the blade 7 has been clamped firmly between the pressure plate 2 and the base part 1, and thus the controller 56 turns off the motor 51.

Further, when the controller 56 gets another order to loosen the blade 7 from the user, e.g. the user presses another key of the microtome, the controller 56 sends another signal to the motor 51 to drive the motor 51 to rotate anti-clockwise, so as to loosen the blade 7. Meanwhile, the controller 56 monitors a position of the nut 55 through a position sensor 58. If the motor 51 pulls the nut 55 to its initial position, the position sensor will be triggered and send a signal to the controller 56. Then, the controller 56 turns off the motor 51 in response to the signal from the position sensor 58. For example, the position sensor is arranged at the initial position of the nut 55, such that when the nut 55 is moved backed to its initial position, the position sensor 58 is triggered and sends the corresponding signal to the control 56. Further, it may be understood that, when the nut 55 returns to its initial portion, the blade 7 has been completely released.

In the blade clamping device 100 according to embodiments of the present disclosure, the blade 7 can be clamped or released automatically, when the user presses a corresponding key. Thus, the user does not need to operate the blade clamping device 100 manually, such that it is convenient for the user to use the microtome, and hence the user experience is enhanced. Further, the blade 7 can be clamped with a uniform force each time, compared with manual clamping operations, and hence the clamping effect is also improved.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A blade clamping device (100) for a microtome, comprising:
a base part (1);
a rotation shaft (3) connected to the base part;
a pressure plate (2) rotatably connected to the base part via the rotation shaft;
a clamping pin (4) received in the base part, and configured to extend out of the base part and push the pressure plate to rotate, so as to clamp a blade (7) between the base part and the pressure plate; and
a drive unit (5) received in the base part, connected to the clamping pin and configured to drive the clamping pin to extend out of the base part.

2. The blade clamping device according claim 1, wherein the base part comprises:
a bottom wall (12);
a side wall (13) connected to the bottom wall and perpendicular thereto; and
a top wall (11) inclined and connected between the bottom wall and the side wall,
wherein the pressure plate is covered on the top wall of the base part.

3. The blade clamping device according to claim 2, wherein the top wall comprises a first oblique segment (111) and a second oblique segment (112) inclined at different angles with respect to the bottom wall.

4. The blade clamping device according to claim 3, wherein the first oblique segment is inclined at a larger angle than the second oblique segment with respect to the bottom wall.

5. The blade clamping device according to claim 3, wherein the pressure plate has an end connected to the base part via the rotation shaft, the end of the pressure plate has an inclined surface matched with the first oblique segment of the top wall of the base part, so as to define a gap therebetween when the end of the pressure plate is rotated around the rotation shaft towards the first oblique segment, and the gap is configured to receive the blade therein.

6. The blade clamping device according to claim 2, wherein the base part further comprises a receiving chamber (15), and the clamping pin and the drive unit are received in the receiving chamber of the base part,
wherein the clamping pin is configured to extend out of the top wall of the base part and configured to move in a direction substantially perpendicular to the top wall of the base part under an action of the drive unit.

7. The blade clamping device according to claim 6, wherein the blade clamping device further comprises an accommodating box (6) arranged in the receiving chamber and configured to accommodate the clamping pin therein,
wherein the accommodating box comprises a body (61) and a cover (62) connected to the body, the clamping pin is received in the body and extends out of the cover.

8. The blade clamping device according to claim 7, wherein the drive unit comprises:
a motor (51) arranged parallel with the accommodating box;
a first gear (52) connected to a output shaft of the motor; and
a second gear (53) connected the accommodating box and meshed with the second gear.

9. The blade clamping device according to claim 8, wherein the drive unit further comprises a spindle (54) connected to the second gear and passing through side walls of the accommodating box and supported thereby, and
the spindle is configured to rotate along with the second gear and abut against the clamping pin, so as to drive the clamping pin to move in the direction substantially perpendicular to the top wall of the base part under an action of the drive unit.

10. The blade clamping device according to claim 9, wherein the drive unit further comprises a nut (55) fitted over the spindle and configured to move along the spindle when the spindle is rotated,
wherein the nut is further configured to abut against the clamping pin when moved along the spindle.

11. The blade clamping device according to claim 10, wherein the nut is configured as a sleeve having internal threads, and the spindle is provided with external threads fitted with the internal threads of the nut, such that the nut is configured to move front and back through a thread fit between the nut and the spindle when the spindle is rotated under the drive of the second gear.

12. The blade clamping device according to claim 11, wherein the nut comprises an inclined side wall (551) configured to be in contact with a bottom of the clamping pin, and the bottom of the clamping pin also comprises an inclined surface fitted with the side wall of the nut,
wherein both the side wall of the nut and the surface of the bottom of the clamping pin are inclined downwards in an extending direction of the spindle from the second gear.

13. The blade clamping device according to claim 10, wherein the drive unit further comprises a controller (56) coupled to the motor and configured to turn on or off the motor, and
the controller is further configured to control the motor to rotate in a first direction to drive the pressure plate to clamp the blade, and also to control the motor to rotate in a second direction to drive the pressure plate to loosen the blade, in which the second direction is opposite to the first direction.

14. The blade clamping device according to claim 13, wherein the drive unit further comprises a motor drive integrated circuit (57) connected between the motor and the controller, and configured to receive a signal from the controller to control the motor to operate.

15. The blade clamping device according to claim 13, wherein the drive unit further comprises a resistor (59) connected in series with the motor, and the controller is configured to monitor a current from the motor through the resistor, and
the controller is further configured to turn off the motor when the current from the motor exceeds a preset current.

16. The blade clamping device according to claim 13, wherein the drive unit further comprises a position sensor (58) arranged at an initial position of the nut, and configured to be triggered when the nut returns to the initial position and to send a signal to the controller, and
the controller is further configured to turn off the motor in response to the signal from the position sensor.
